(19) United States
(12) Patent Application Publication
(10) Pub. No.: US 2025/0106794 A1
(43) Pub. Date: Mar. 27, 2025

(54) INFORMATION DETERMINATION METHOD AND APPARATUS, AND TERMINAL

(71) Applicant: VIVO MOBILE COMMUNICATION CO., LTD., Dongguan (CN)

(72) Inventors: Qi HONG, Dongguan (CN); Gen LI, Dongguan (CN)

(73) Assignee: VIVO MOBILE COMMUNICATION CO., LTD., Dongguan (CN)

(21) Appl. No.: 18/970,885

(22) Filed: Dec. 5, 2024

Related U.S. Application Data
(63) Continuation of application No. PCT/CN2023/098863, filed on Jun. 7, 2023.

(30) Foreign Application Priority Data
Jun. 8, 2022 (CN) 202210652965.3

(51) Int. Cl. H04W 56/00; H04L 27/26

(52) U.S. Cl. CPC H04W 56/0015; H04L 27/26025

(57) ABSTRACT

This application discloses an information determination method, a terminal, and non-transitory computer-readable storage medium. The information determination method includes: a terminal determines first information based on a non cell defining synchronization signal and PBCH block (NCD-SSB) detected on a first synchronization raster, and the terminal determines target information based on the first information. The first information includes at least one piece of information in a master information block (MIB) in the NCD-SSB, first resource information of the first synchronization raster, or a subcarrier spacing (SCS) of the NCD-SSB. The target information includes at least one of the following: second resource information of a first frequency-domain resource on which a second synchronization raster exists, or third resource information of a second frequency-domain resource on which no CD-SSB exists. The second synchronization raster is a synchronization raster of a cell defining synchronization signal and PBCH block (CD-SSB).

### CROSS-REFERENCE TO RELATED APPLICATIONS

This application is a continuation of International Application No. PCT/CN 2023/098863, filed on Jun. 7, 2023, which claims the priority of Chinese Patent Application No. 202210652965.3 filed on Jun. 8, 2022. The entire contents of each of the above-referenced applications are expressly incorporated herein by reference.

### TECHNICAL FIELD

This application pertains to the field of communication technologies, and specifically, to an information determination method and apparatus, and a terminal.

### BACKGROUND

When a terminal is just turned on for cell searching, the terminal can only detect, according to a frequency band supported by an operator and the terminal, a Synchronization Signal and PBCH block (SSB) for downlink time-frequency synchronization. Due to a small granularity of a global frequency raster, if blind detection is directly performed according to the global frequency raster, a synchronization delay will be large. Therefore, the concept of synchronization raster is introduced in a New Radio (NR) system, and a search range is limited by a Global Synchronization Channel Number (GSCN). However, when the terminal performs cell searching based on a Non Cell Defining SSB (NCD-SSB), it is difficult for the terminal to determine the GSCN of a Cell Defining SSB (CD-SSB) due to the fact that the NCD-SSB does not include an SSB associated with System Information Block (SIB) 1. The terminal can only determine the GSCN of the CD-SSB through blind detection to access to a cell, which causes low efficiency of the terminal accessing to a cell.

### SUMMARY

Embodiments of this application provide an information determination method and apparatus, and a terminal.

In a first aspect, an information determination method is provided, including:
determining, by a terminal, first information based on a non cell defining synchronization signal and PBCH block (NCD-SSB) detected on a first synchronization raster, wherein the first information includes at least one piece of information in a master information block (MIB) in the NCD-SSB, first resource information of the first synchronization raster, or a subcarrier spacing (SCS) of the NCD-SSB; and
determining, by the terminal, target information based on the first information, wherein the target information includes at least one of the following:
second resource information of a first frequency-domain resource on which a second synchronization raster exists, wherein the second synchronization raster is a synchronization raster of a cell defining synchronization signal and PBCH block (CD-SSB); and
third resource information of a second frequency-domain resource on which no CD-SSB exists.

In a second aspect, an information determination apparatus is provided, including:
a first determining module, configured to: determine first information based on a NCD-SSB detected on a first synchronization raster, wherein the first information includes at least one piece of information in a MIB in the NCD-SSB, first resource information of the first synchronization raster, or a SCS of the NCD-SSB; and
a second determining module, configured to determine target information based on the first information, wherein the target information includes at least one of the following:
second resource information of a first frequency-domain resource on which a second synchronization raster exists, wherein the second synchronization raster is a synchronization raster of a CD-SSB; and
third resource information of a second frequency-domain resource on which no CD-SSB exists.

In a third aspect, a terminal is provided. The terminal includes a processor and a memory. The memory stores a program or an instruction runnable on the processor, and the program or instruction, when run by the processor, implements the steps of the information determination method as described in the first aspect.

In a fourth aspect, a terminal is provided, including a processor and a communication interface. The processor is configured to: determine first information based on a NCD-SSB detected on a first synchronization raster, wherein the first information includes at least one piece of information in a MIB in the NCD-SSB, first resource information of the first synchronization raster, or a SCS of the NCD-SSB; and
configured to determine target information based on the first information, wherein the target information includes at least one of the following:
second resource information of a first frequency-domain resource on which a second synchronization raster exists, wherein the second synchronization raster is a synchronization raster of a CD-SSB; and
third resource information of a second frequency-domain resource on which no CD-SSB exists.

In a fifth aspect, a communication system is provided, including: a terminal and a network side device. The terminal may be configured to execute the steps of the information determination method as described in the first aspect.

In a sixth aspect, a readable storage medium. The readable storage medium stores a program or an instruction, wherein the program or instruction, when run by a processor, implements the steps of the information determination method as described in the first aspect.

In a seventh aspect, a chip is provided. The chip includes a processor and a communication interface. The communication interface is coupled with the processor. The processor is configured to run a program or an instruction to implement the information determination method as described in the first aspect.

In an eighth aspect, a computer program/program product is provided. The computer program/program product is stored in a storage medium. The computer program/program product is run by at least one processor to implement the steps of the information determination method as described in the first aspect.

In this embodiment of this application, at initial access to a cell, after detecting an NCD-SSB on the first synchronization raster, the terminal can determine, based on the first information, a frequency-domain resource of the second synchronization raster on which a CS-SSB exists, so that the terminal can perform the SSB detection based on the frequency-domain resource of the second synchronization raster, to ensure that the terminal can access to the cell quickly, and the efficiency of the terminal accessing to the cell is improved. In some embodiments, the terminal can further determine, based on the first information, a frequency-domain resource on which no CD-SSB exists, to avoid the terminal from performing the SSB detection on the frequency-domain resource on which no CD-SSB exists. This can effectively improve the efficiency of blind detection of the terminal and is more helpful for the terminal to quickly locate an SSB to access to a cell.

### BRIEF DESCRIPTION OF THE DRAWINGS

FIG. 1 is a block diagram of a wireless communication system applicable to an embodiment of this application;

FIG. 2a is a schematic diagram of values of k_{SSB} and GSCN migration at frequency band FR1;

FIG. 2b is a schematic diagram of values of k_{SSB} and GSCN migration at frequency band FR2;

FIG. 3 is a flowchart of an information determination method according to an embodiment of this application;

FIG. 4 is a structural diagram of an information determination apparatus according to an embodiment of this application;

FIG. 5 is a structural diagram of a communication device according to an embodiment of this application; and

FIG. 6 is a structural diagram of a terminal according to an embodiment of this application.

### DETAILED DESCRIPTION

The technical solutions in embodiments of this application are described in the following with reference to the accompanying drawings in the embodiments of this application. Apparently, the described embodiments are merely some rather than all the embodiments of this application. All other embodiments obtained by persons skilled in the art based on the embodiments of this application fall within the protection scope of this application.

This specification and claims of this application, and terms “first” and “second” are used to distinguish similar objects, but are unnecessarily used to describe a specific sequence or order. It should be understood that the terms used like this are interchangeable where appropriate, so that the embodiments of this application can be implemented in an order other than those illustrated or described here. Furthermore, objects distinguished by “first”, “second”, and the like are usually of the same class and do not limit the number of objects. For example, the first object can be one or multiple. In addition, “and/or” used in this specification and the claims represents at least one of the connected objects. Symbol “/” usually represents an “or” relationship between front and back associated objects.

It is worth noting that the technology described in the embodiments of this application is not limited to a Long Term Evolution (LTE)/LTE-Advanced (LTE-A) system, and in some embodiments, can be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are often used interchangeably, and the described technology can be applied to both the aforementioned systems and radio technologies, as well as other systems and radio technologies. The following describes a New Radio (NR) system for the example purpose and uses the term NR in most of the following descriptions. However, in some embodiments, these technologies can be applied to applications other than the NR system application, such as a 6th Generation (6G) communication system.

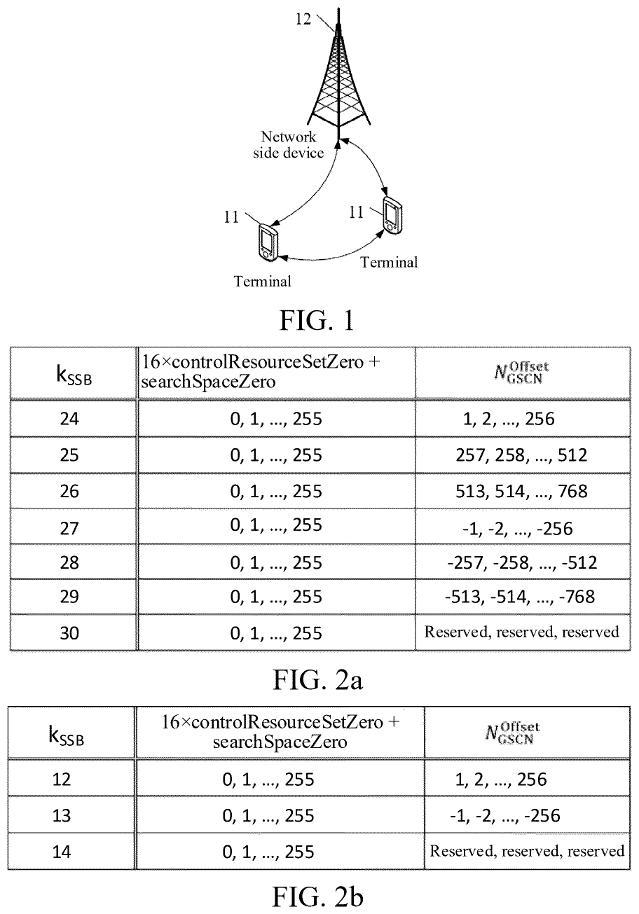

FIG. 1 shows a block diagram of a wireless communication system applicable to an embodiment of this application. The wireless communication system includes a terminal 11 and a network side device 12. The terminal 11 can be a mobile phone, a tablet personal computer, a laptop computer or also referred to as a laptop, a Personal Digital Assistant (PDA), a handheld computer, a netbook, ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), a smart home (home devices with wireless communication functions, such as a refrigerator, a television, a washing machine, or furniture), a game console, a personal computer (PC), a teller machine, a vending machine, or other terminal side devices. The wearable device includes: a smart watch, a smart hand ring, a smart headphone, smart glasses, a smart jewelry (a smart bracelet, a smart ring, a smart necklace, a smart bangle, a smart anklet, and the like), a smart wristband, smart clothing, and the like. It should be noted that, in the embodiments of this application, a specific type of the terminal 11 is not limited. The network side device 12 may include an access network device or a core network device. In some embodiments, the access network device may be referred to as a radio access network device, a Radio Access Network (RAN), a radio access network function, or a radio access network unit. The access network device may include a base station, a Wireless Local Area Networks (WLAN) access point, a WiFi node, or the like. The base station can be referred to as a node B, an evolution node B (eNB), an access point, a Base Transceiver Station (BTS), a radio base station, a radio transceiver, a Basic Service Set (BSS), an Extended Service Set (ESS), a home B node, a home evolution type B node, a Transmitting Receiving Point (TRP), or any other suitable term in the art, as long as the same technical effects are achieved. The base station is not limited to a particular technical vocabulary. It should be noted, in the embodiments of this application, only the base station in the NR system is taken as an example, but a specific type of the base station is not limited.

For case of understanding the technical solutions of the embodiments of this application, the following will make an explanation on relevant concepts possibly involved in the embodiments of this application.

In an NR system, a CD-SSB is defined as an SSB associated with SIB1. SIB1 defines scheduling information of other SIBs and contains information for initial access of a terminal. In addition, a frequency position of the CD-SSB needs to be on a system synchronization raster.

An NCD-SSB is correspondingly defined as an SSB that is not associated with SIB1. The NCD-SSB can be used for secondary cell synchronization and can also be used as a measurement signal for terminal configuration. NCD-SSB may not necessarily be located on the system synchronization raster. If the NCD-SSB is located on the system synchronization raster, a GSCN of the CD-SSB can be indicated through information carried by the NCD-SSB. The most important information in an SSB (e.g. CD-SSB and NCD-SSB) is a MIB. The MIB includes a physical broadcast channel (PBCH). The PBCH includes data of a total of 32 bits, with bits 0 to 23 from a Radio Resource Control (RRC) layer and bits 24 to 31 from a physical (Physical, PHY) layer.

Information carried by the RRC layer includes:
system frame number (systemFrameNumber);
subcarrier spacing common (subCarrierSpacingCommon): used for indicating a subcarrier spacing of a downlink signal in an initial access flow and indicating a subcarrier spacing of SIB1/other system information (other system information, OSI)/initial access message 2 (Msg2)/Msg4/paging message;
SSB subcarrier offset (ssb-SubcarrierOffset); used for indicating a number of subcarrier spacings between a lowest subcarrier of the SSB and the latest physical resource block (Physical Resource Block, PRB);
demodulation reference signal (DMRS)-type A-position (dmrs-Type A-Position): used for indicating a configuration of a physical downlink shared channel (PDSCH);
pdcch-ConfigSIB1: used for indicating a configuration of an SIB1_physical downlink control channel (PDCCH), including a control resource set (CORESET) (similar to a control format indication (CFI) of an LTE) and a search space configuration;
cell barred (cellBarred): an access control parameter of RRC for identifying whether the cell is barred;
an intra frequency reselection (intraFreqReselection): an access control parameter of RRC for identifying whether the cell allows same frequency reselection;
spare: reserving bit.

pdcch-ConfigSIB1 carries information of CORESET #0 and search space 0.

Information carried by the PHY layer includes:
lower 4 bits of system frame number, 4 bit;
5 ms half-frame number, 1 bit;
beam identification number, or highest bit (1 bit) of k_{SSB}+beam identification number (2 bit), 3 bit.

It should be noted that, if the NCD-SSB is located on the system synchronization raster, the NCD-SSB can indicate the GSCN of the CD-SSB through an ssb-SubcarrierOffset indication field and a pdcch-ConfigSIB1 indication field in the PBCH of the MIB.

k_{SSB}:

The SSB subcarrier offset information domain (ssb-SubcarrierOffset) is used for indicating a value k_{SSB} of a subcarrier offset between the SSB and CORESET #0. A range of the offset includes 0 to 23 subcarriers and 0 to 11 subcarriers, represented by 5 bits (5 bit) (4 bits are indicated by ssb-Subcarrier Offset, and highest bit of 1 bit is indicated by a PBCH PHY layer) and 4 bits respectively, corresponding to frequency ranges FR1 and FR2 respectively. When k_{SBB}>23 (FR1) or k_{SBB}>11 (FR2), this range of the value is used for indicating that the current SSB is not associated with SIB1, but some of these values can be used for indicating the GSCN of the CD-SSB, as shown in FIG. 2a and FIG. 2b.

It should be noted that, when value k_{SBB}=31 (FR1) or value k_{SBB}=15 (FR2), a UE considers that no CD-SSB exists within a GSFN range.

When a terminal is just turned on for cell searching, the terminal can only detect, according to a frequency band supported by an operator and the terminal, an SSB signal for downlink time-frequency synchronization. Due to a small granularity of a global frequency raster, causing an NR Absolute Radio Frequency Channel Number (NR-ARFCN) to have a large value range, if blind detection is directly performed according to the global frequency raster, a synchronization delay will be large. In some embodiments, to effectively reduce the synchronization delay of this process, a 3GPP has defined the concept of synchronization raster and limited a search range through a GSCN. As shown in Table 1, the synchronization raster is 1200 kHz within a range of 0 to 3000 MHz. Within a range of 3000 to 24250 MHZ, the synchronization raster is 1.44 MHz. Within a range of 24250 to 100000 MHz, the synchronization raster is 17.28 MHz. Similar to NR-ARFCN, GSCN also defines a frequency range of 0-100 GHz, and each GSCN corresponds to a detection frequency point for one SSB.

TABLE 1
GSCN parameters for the global frequency raster

| | | SS block frequency position SSREF | | |
|---|---|---|---|---|
| Frequency range | | (SS block frequency position SS_{REF}) | GSCN | Range of GSCN |
| 0 to 3000 | MHz | N * 1200 kHz + M * 50 kHz, | 3N + (M − 3)/2 | 2-7498 |
| | | N = 1:2499, M ϵ {1, 3, 5} (Note) | | |
| 3000-24250 | MHz | 3000 MHz + N * 1.44 MHz | 7499 + N | 7499-22255 |
| | | N = 0:14756 | | |
| 24250-100000 | MHz | 24250.08 MHz + N * 17.28 MHz | 22256 + N | 22256-26639 |

N = 0:4383

NOTE:
The default value for operating bands which only supports SCS spaced channel raster(s) is M = 3 (The default value for operating bands which only supports SCS spaced channel raster(s) is M = 3).

When the terminal is just turned on for cell searching, it is possible that corresponding data (only including SSB and MIB, but not including SIB1) has been detected on the NCD-SSB. At this point, to reduce the complexity of blind detection of the UE, the data can be used to directly find the location of the CD-SSB. For example, by the configurations of the ssb-SubcarrierOffset indication field and the pdcch-ConfigSIB1 indication field, a distance (the last column in FIG. 2a and FIG. 2b) between the sync raster of the CD-SSB and the sync raster of the NCD-SB can be searched for using the tables shown in FIG. 2a and FIG. 2b.

The design of a synchronization raster (sync raster) will be introduced.

### For an Unlicensed Band:

Synchronization rasters corresponding to a primary cell (Pcell) and a primary secondary cell (PScell) are determined by the following mode:
1) For 120 kHz SCS: 24156+6*N−3*floor ((N+5)/18), N=0:137; and
2) For 480 kHz SCS: 24162+24*N−12*floor ((N+4)/18), N=0:33.

For a licensed band, a frequency-domain position of a synchronization raster will be determined using Table 2 below.

TABLE 2
Applicable SS raster entries per operating band (FR2)

| | Synchronization signal | | Synchronization | |
|---|---|---|---|---|
| NR operating | block subcarrier spacing | | signal block pattern | Range of GSCN |
| band | (SS Block SCS) | | (SS Block pattern) | (First-<Step size>-Last) |
| n257 | 120 | kHz | Case D | 22388-<1>-22558 |
| | 240 | kHz | Case E | 22390-<2>-22556 |
| n258 | 120 | kHz | Case D | 22257-<1>-22443 |
| | 240 | kHz | Case E | 22258-<2>-22442 |
| n259 | 120 | kHz | Case D | 23140-<1>-23369 |
| | 240 | kHz | Case E | 23142-<2>-23368 |
| n260 | 120 | kHz | Case D | 22995-<1>-23166 |
| | 240 | kHz | Case E | 22996-<2>-23164 |
| n261 | 120 | kHz | Case D | 22446-<1>-22492 |
| | 240 | kHz | Case E | 22446-<2>-22490 |
| n262 | 120 | kHz | Case D | 23586-<1>-23641 |
| | 240 | kHz | Case E | 23588-<2>-23640 |
| [n264] | 120 | kHz | Case D | 24674-<3>-24959 |
| | 480 | kHz | Case F | 24677-<12>-24953 |

| | | |
|---|---|---|
| 960 kHz (NOTE) | Case G | 24680-<6>-24950 |

NOTE:
This SSB SCS is not used for initial access.

Values of step sizes at different frequency band numbers and different SSB SCS frequency-domain ranges are determined in Table 2 above, which can further determine the frequency-domain position of the synchronization raster.

An information determination method provided in an embodiment of this application will be described below through some embodiments and their application scenes in combination with the accompanying drawings.

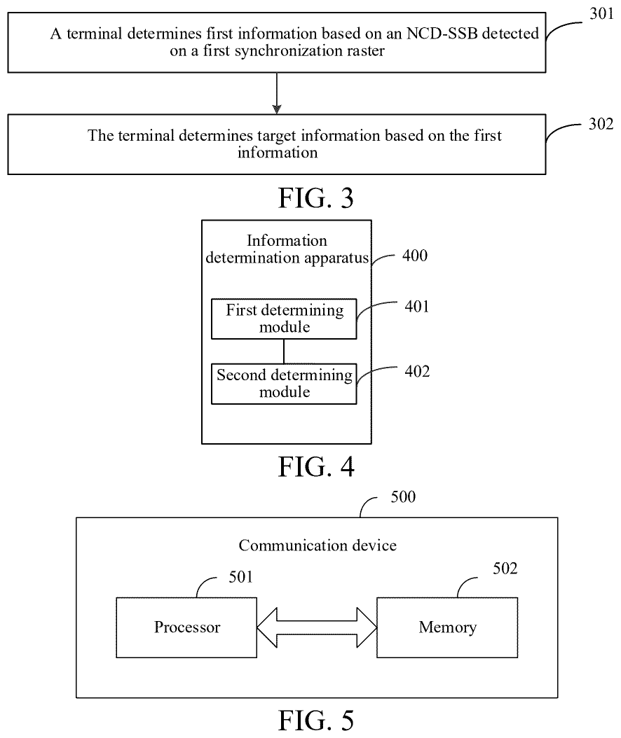

Referring to FIG. 3, FIG. 3 is a flowchart of an information determination method according to an embodiment of this application. As shown in FIG. 3, the method includes the following steps:

Step 301. A terminal determines first information based on an NCD-SSB detected on a first synchronization raster.

The first information includes at least one piece of information in a MIB in the NCD-SSB, first resource information of the first synchronization raster, or a SCS of the NCD-SSB.

In this embodiment of this application, after detecting the NCD-SSB on the first synchronization raster, the terminal can determine the first information based on the NCD-SSB. For example, the first information may be the information in the MIB of the NCD-SSB, or the first information may be resource information of the first synchronization raster, namely, the first resource information, the first resource information, or the first information may be the SCS of the NCD-SSB, or the first information may be the first resource information of the first synchronization raster and the SCS in the NCD-SSB, or the like. Information content included in the first information may be other possible situations, which will not be listed in detail in this embodiment.

In some embodiments, the first resource information of the first synchronization raster includes at least one of the following:
a frequency band type of a frequency band where the first synchronization raster is located;
a frequency band position of the frequency band where the first synchronization raster is located; and
a frequency band number of the frequency band where the first synchronization raster is located.

The frequency band type includes a licensed band and an unlicensed band. Namely, the frequency band where the first synchronization raster is located is either the licensed band or the unlicensed band.

In some embodiments, a frequency band number of the frequency band where the first synchronization raster is located may be a known frequency band number, such as n264 and n263. The frequency band position where the first synchronization raster is located can be a specific frequency band, such as 24156 and 24162.

In this embodiment of this application, in a case that the first information includes the information in the MIB of the NCD-SSB, the first information is indicated by a bit in a first indication field of the MIB. The first indication field is an indication field in a PBCH of the MIB.

In some embodiments, the first indication field includes at least one of the following:
a system frame number indication field;
a subcarrier spacing indication field;
a demodulation reference signal (DMRS)-type A-position indication field;
cell barred indication field;
an intra frequency reselection indication field; and
a spare indication field.

The system frame number (systemFrameNumber) indication field is used for indicating a system frame number. A complete frame number requires 10 bits, and the frame number in a payload of the MIB only has high 6 bits. Low 4 bits are transmitted in non-MIB bits in a PBCH transmission block.

The subcarrier spacing (subCarrierSpacing) common indication field is used for indicating a subcarrier spacing of a downlink signal in an initial access flow and indicating a subcarrier spacing of SIB1/OSI/Msg2 of initial access/Msg4/paging message.

The dmrs-Type A-Position indication field is used for indicating a configuration of a PDSCH DMRS reference signal.

The cell barred (cellBarred) indication field is used for indicating an access control parameter of an RRC and identifying whether the cell is barred.

The intra frequency reselection (intraFreqReselection) indication field is used for indicating an access control parameter of an RRC and identifying whether the cell allows same-frequency reselection.

The spare indication field is used for reserving bit.

In this embodiment of this application, the first information may be indicated in at least one of the above-mentioned indication fields. For example, the frequency-domain position or frequency-domain number of the first synchronization raster can be indicated by the system frame number indication field, or the frequency-domain position or frequency-domain number of the first synchronization raster can be indicated by the cell barred indication field, or the frequency-domain position or frequency-domain number of the first synchronization raster can be jointly indicated by the system frame number indication field and the bit in the subcarrier spacing common (subCarrierSpacingCommon) indication field. This embodiment does not provide too many examples.

In this way, the terminal can determine the first information based on the information in the indication field of the PBCH in the MIB carried by the NCD-SSB.

Step 302. The terminal determines target information based on the first information.

The target information includes at least one of the following:
second resource information of a first frequency-domain resource on which a second synchronization raster exists, wherein the second synchronization raster is a synchronization raster of a CD-SSB; and
third resource information of a second frequency-domain resource on which no CD-SSB exists.

In some embodiments, the second resource information of the first frequency-domain resource may be a frequency-domain number, a frequency-domain position, a frequency-domain offset, and other information of the first frequency-domain resource. The third resource information of the second frequency-domain resource may be a frequency-domain number, a frequency-domain position, a frequency-domain offset, and other information of the second frequency-domain resource.

Exemplarily, the terminal can determine, based on the first information, the frequency-domain number or frequency-domain position of the second synchronization raster on which a CD-SSB exists, and/or determine, based on the first information, the frequency-domain number or frequency-domain position of the second synchronization raster on which no CD-SSB exists.

For example, the first information includes the frequency-domain position of the first synchronization raster of the NCD-SSB. The terminal may find out, based on the frequency-domain position of the first synchronization raster, the frequency-domain position of the nearest second synchronization raster on which a CD-SSB exists, and then determine, based on the frequency-domain position of the first synchronization raster of the NCD-SSB, the frequency-domain position of the second synchronization raster on which a CD-SSB exists.

In some embodiments, the first information may include the information in the MIB in the NCD-SSB. The terminal may determine, based on an indication in an indication field in the MIB, the frequency-domain position or frequency-domain number of the second synchronization raster on which a CD-SSB exists. For example, the system frame number indication field in the PBCH in the MIB can indicate the frequency-domain position of the second synchronization raster. Thus, the terminal can determine, based on the information in the MIB, the frequency-domain position of the second synchronization raster on which a CD-SSB exists.

In some embodiments, the first information may include the information in the MIB and the SCS in the NCD-SSB. Different SCSs may correspond to different step sizes. The terminal may determine, based on the SCS in the NCD-SSB and the indication of the information in the MIB, the frequency-domain position or frequency-domain number of the second synchronization raster on which a CD-SSB exists.

For another example, the first information includes the information in the MIB. The information in the MIB may be a frequency-domain resource or frequency-domain number indicating that no CD-SSB exists. Thus, the terminal determines, based on the first information, the third resource information of the second frequency-domain resource on which no CD-SSB exists.

It should be noted that, in some embodiments, the specific information content included in the first information may be other possible situations. The terminal determining, based on the first information, the target information may be other possible solutions. This embodiment of this application does not provide too many examples.

In this embodiment of this application, the terminal determines the first information based on the NCD-SSB detected on the first synchronization raster, wherein the first information includes at least one piece of the information in the MIB of the NCD-SSB, the first resource information of the first synchronization raster, or the SCS of the NCD-SSB. Thus, based on the first information, the terminal can determine the second resource information of the first frequency-domain resource of the second synchronization raster on which a CD-SSB exists, and/or determine the third resource information of the second frequency-domain resource on which no CD-SSB exists. In this way, at initial access to a cell, after detecting the NCD-SSB on the first synchronization raster, the terminal can determine, based on the first information, the frequency-domain resource of the second synchronization raster on which a CS-SSB exists, so that the terminal can perform the SSB detection based on the frequency-domain resource of the second synchronization raster, to ensure that the terminal can access to the cell quickly, and the efficiency of the terminal accessing to the cell is improved. In addition, the terminal can further determine, based on the first information, the frequency-domain resource on which no CD-SSB exists, to avoid the terminal from performing the SSB detection on the frequency-domain resource on which no CD-SSB exists. This can effectively improve the efficiency of blind detection of the terminal and is more helpful for the terminal to quickly locate an SSB to access to a cell.

In some embodiments, the terminal determines target information based on the first information, which includes:
The terminal determines a target step size based on the first information, wherein the target step size is used for indicating the second synchronization raster and/or used for indicating the second frequency-domain resource on which no CD-SSB exists; and
the terminal determines target information based on the target step size and second information,
wherein the second information includes at least one of the following:
a frequency-domain number or a frequency-domain position of the first synchronization raster; and
a frequency-domain number offset parameter or a frequency-domain position offset parameter of the second synchronization raster relative to the first synchronization raster.

In this embodiment of this application, the first information may include the target step size. For example, an indication field in the PBCH in the MIB may indicate the target step size, or that the frequency band number where the first synchronization raster is located is associated with the target step size, or that the SCS of the NCD-SSB is associated with the target step size, or the like. Thus, the terminal can determine the target step size based on the first information. The target step size is used for indicating a frequency-domain resource of the second synchronization raster on which a CD-SSB exists and/or used for indicating a frequency-domain resource on which no CD-SSB exists. The terminal determines, based on the target step size and the second information, the frequency-domain resource of the second synchronization raster on which a CD-SSB exists and/or the frequency-domain resource on which no CD-SSB exists.

In some embodiments, the terminal determines a target step size based on the first information, which includes at least one of the following:
The terminal determines the target step size based on an indication in an indication field of the MIB in the detected NCD-SSB;
the terminal determines the target step size based on the frequency band type of the frequency band where the first synchronization raster is located, wherein different frequency band types correspond to different step sizes;
the terminal determines the target step size based on the frequency band number of the frequency band where the first synchronization raster is located, wherein different frequency band numbers correspond to different step sizes; and
the terminal determines the target step size based on the SCS of the detected NCD-SSB, wherein the SCSs of different SSBs correspond to different step sizes.

For example, some indications in the indication field of the MIB of the NCD-SSB can be used for indicating the target step size. For example, the system frame number indication field of the PBCH in the MIB of the NCD-SSB may indicate the target step size, and the terminal can then determine the target step size based on the detected NCD-SSB. In some embodiments, the indication field may be other possible situations. This embodiment does not specifically limit it.

In some embodiments, the terminal can determine the target step size based on the frequency band type of the frequency band where the detected first synchronization raster is located. For example, agreed or pre-defined different frequency band types correspond to different step sizes. For example, a step size corresponding to a licensed band is k1, and a step size corresponding to an unlicensed band is k2. The terminal can then determine the target step size based on the frequency band type of the frequency band where the first synchronization raster is located.

In some embodiments, agreed or pre-defined different frequency band numbers correspond to different step sizes. For example, a step size corresponding to n263 is k1, and a step size corresponding to n264 is k2. The terminal can then determine the target step size based on the frequency band number of the frequency band where the first synchronization raster is located.

In some embodiments, SCSs of agreed or pre-defined different SSBs correspond to different step sizes. The terminal can then determine the target step size based on the SCS of the detected NCD-SSB.

In addition, the terminal can further determine the target step size based on the frequency band number and frequency band type of the frequency band where the first synchronization raster is located, or the terminal can determine the target step size based on an indication in an indication field of MIB of the NCD-SSB and the frequency band number of the frequency band where the first synchronization raster is located, or the terminal can determine the target step size based on the frequency band number or frequency band type of the frequency band where the first synchronization raster is located and the SCS. Of course, there are other possible modes used by the terminal to determine the target step size. This embodiment will not provide too many examples.

In this embodiment of this application, after determining the target step size, the terminal determines, based on the target step size and the second information, the first frequency-domain resource of the second synchronization raster on which a CD-SSB exists and/or determines the second frequency-domain resource on which no CD-SSB exists.

In some embodiments, the second information may include the frequency-domain number or frequency-domain position of the first synchronization raster. Assuming that the target step size is used for indicating the frequency-domain number or frequency-domain position of the second synchronization raster on which a CD-SSB exists, based on the second information and the target step size, the terminal can determine the frequency-domain number or frequency-domain position of the second synchronization raster on which a CD-SSB exists, and/or can further determine the frequency-domain number or frequency-domain position on which no CD-SSB exists.

In some embodiments, if the second information includes the frequency-domain number or frequency-domain position of the first synchronization raster, and the frequency-domain number offset parameter of the second synchronization raster relative to the first synchronization raster, the terminal can determine the frequency-domain number or frequency-domain position of the second synchronization raster based on the second information and the target step size.

In some embodiments, the terminal determines target information based on the target step size and second information, which includes:
the terminal determines a first product based on the target step size and the frequency-domain position offset parameter; and
the terminal determines a frequency-domain position of the second synchronization raster based on a sum of the first product and the frequency-domain position of the first synchronization raster.

In this implementation, the second information may include the frequency-domain position of the first synchronization raster and the frequency-domain position offset parameter of the second synchronization raster relative to the first synchronization raster. After determining the target step size and the second information mentioned above, the terminal obtains the first product of the target step size and the frequency-domain position offset parameter, and determines the sum of the first product and the frequency-domain position of the first synchronization raster as the frequency-domain position of the second synchronization raster.

In some embodiments, the frequency-domain position in the above implementation can be the frequency-domain number, and the frequency-domain position offset parameter is correspondingly the frequency-domain number offset parameter. In some embodiments, the terminal determines target information based on the target step size and second information, which includes:
the terminal determines a third product based on the target step size and the frequency-domain number offset parameter; and
the terminal determines a frequency-domain number of the second synchronization raster based on a sum of the third product and the frequency-domain number of the first synchronization raster.

In this implementation, the second information may include the frequency-domain number of the first synchronization raster and the frequency-domain number offset parameter of the second synchronization raster relative to the first synchronization raster. After determining the target step size and the second information, the terminal obtains the third product of the target step size and the frequency-domain number offset parameter, and determines the sum of the third product and the frequency-domain number of the first synchronization raster as the frequency-domain number of the second synchronization raster. The NR system can agree in advance that different frequency-domain numbers correspond to different frequency-domain positions or frequency-domain ranges.

For example, in an implementation, the terminal can determine the target step size jointly based on the frequency-domain number or frequency-domain position of the first synchronization raster and the SCS of the detected NCD-SSB, and then determine the frequency-domain position or frequency-domain number of the second synchronization raster based on the product of the target step size and the above frequency-domain position offset parameter or frequency-domain number offset parameter plus the frequency-domain position or frequency-domain number of the first synchronization position. Subsequent specific embodiment examples can be referred to.

In some embodiments, the frequency-domain number or the frequency-domain position of the first synchronization raster includes a GSCN of the first synchronization raster. The terminal determines target information based on the target step size and second information, which includes:
The terminal determines a second product based on the target step size and the frequency-domain number offset parameter or the frequency-domain position offset parameter; and
the terminal determines a GSCN of the second synchronization raster based on a sum of the second product and the GSCN of the first synchronization raster.

In this implementation, after determining the target step size, the terminal calculates the second product of the frequency-domain position offset parameter (or frequency-domain number offset parameter) of the second synchronization raster relative to the first synchronization raster and the target step size. The GSCN of the first synchronization raster and the second product are summed to obtain the GSCN of the second synchronization raster.

For example, the GSCN of the second synchronization raster=N_{GSCN}^{Reference}+N_{GSCN}^{Size}·N_{GSCN}^{Offset}

where N_{GSCN}^{Reference} is the GSCN of the first synchronization raster; N_{GSCN}^{Size} is the target step size; and N_{GSCN}^{Offset} is the frequency-domain position offset parameter or frequency-domain number offset parameter of the second synchronization raster relative to the first synchronization raster.

After determining the frequency-domain resource of the second synchronization raster, e.g., the frequency-domain number, the frequency-domain position, or the GSCN, the terminal can perform SSB detection on the frequency-domain resource of the second synchronization raster.

In some embodiments, the method further includes at least one of the following:
in a case that the terminal determines, based on the first information, the first frequency-domain resource of the second synchronization raster on which a CD-SSB exists, the terminal performs SSB detection on the first frequency-domain resource; and
in a case that the terminal determines, based on the first information, the second frequency-domain resource on which no CD-SSB exists, the terminal does not perform SSB detection on the second frequency-domain resource.

For example, after determining, based on the first information, the first frequency-domain resource (e.g. the frequency-domain position or the frequency-domain number) of the second synchronization raster on which a CD-SSB exists, the terminal performs the SSB detection on the second frequency-domain resource, to ensure that the terminal can access to a cell based on the detected SSB and ensure the communication of the terminal.

In some embodiments, after determining, based on the first information, the second frequency-domain resource on which no CD-SSB exists, the terminal does not perform the SSB detection on the second frequency-domain resource. This helps the terminal eliminate some frequency-domain resources during the blind detection and narrows the frequency-domain resource range for blind detection, thereby effectively improving the efficiency of blind detection, to help the terminal detect a synchronization raster on which a CD-SSB exists as soon as possible and ensure that the terminal accesses to the cell.

For better understanding, the technical solutions of this embodiment of this application are described below by using several specific embodiments.

### Embodiment I

Step 1: A UE detects an NCD-SSB in a first sync raster in an initial search process.

Step 2: The UE determines, jointly according to information in an MIB of the NCD-SSB, an SCS, and a value of the current first sync raster, a position of a second sync raster containing a CD-SSB.

A value of a step size is determined jointly according to a frequency band type (an unlicensed band or a licensed band) and the SCS.

It should be noted that specific values of a step size can be pre-defined at different SCSs and different operating bands, as shown in Table 3 below.

TABLE 3
Step sizes at different SCSs and different operating bands

| Subcarrier spacing common | | Step size |
|---|---|---|
| (subCarrierSpacingCommon) | NR operating band | N_{GSCN}^{Size} |
| scs120 | n264 (licensed band) | 3 |
| scs480 | n264 (licensed band) | 12 |
| scs120 | n263 (unlicensed band) | 6 |
| scs480 | n263 (unlicensed band) | 24 |

For example: The UE performs blind detection on different SCSs. For SCS 120, if sync=24156 is detected (refer to Table 3 above), it determines that the frequency band type is an unlicensed band or the frequency band number is n263, and the step size at this time is considered to be 6 (refer to Table 3 above). If sync=24674 is detected, it determines that the frequency band type is an unlicensed band or the frequency band number is n264, and the step size at this time is considered to be 3. For SCS 480, if sync=24162 is detected, it determines that the step size at this time is 24. If sync=24677 is detected, it determines that the step size at this time is 12.

Step 3: The UE finds out a position of a CD-SSB sync raster according to an indication and performs SSB detection.

It should be noted that, the first step for the UE to access to a cell is to perform blind SSB detection on different SCSs and a sync raster. If an SSB is detected, the SSB will be decoded. At this time, if it is found that the detected SSB is associated with SIB1 information, the UE considers that the sync raster can be used for initial access. If the detected SSB is not associated with SIB1 information, the UE considers that the sync raster cannot be used for initial access. At this time, the UE determines, according to information (mainly k_{SSB}) obtained by decoding the SSB, whether the position of the nearest CD-SSB sync raster can be found out for the NCD-SSB sync raster. If, for FR1: 24≤k_{SBB}≤29 or, for FR2: If 12≤k_{SSB}≤13, the position of the nearest CD-SSB sync raster can be calculated according to N_{GSCN}^{Reference}+N_{GSCN}^{Offset}, where N_{GSCN}^{Reference} is a GSCN of the NCD-SB sync raster, and N_{GSCN}^{Offset} is a GSCN offset value (refer to FIG. 2a and FIG. 2b).

### Embodiment II

Step 1: A UE detects a corresponding signal in a sync raster of an NCD-SSB in an initial search process.

Step 2: The UE determines, based on information in an MIB of the NCD-SSB, a position of a sync router that can reside.

A value of a step size is indicated in a PBCH. For example, it can be indicated by bits in an existing indication field in the PBCH, e.g. a remaining entry in pdcch-ConfigSIB1, or a spare bit indication field (spare bit), or a united indication.

Step 3: The UE finds out a position of a CD-SSB sync raster according to an indication and performs SSB detection.

### Embodiment III

Step 1: A UE detects a corresponding signal in a sync raster of an NCD-SSB in an initial search process.

Step 2: The UE determines, based on information in an MIB of the NCD-SSB and an SCS or a frequency band type (licensed band or unlicensed band), a position of a sync router that can reside.

A value of a step size is determined according to the SCS or the frequency band type (licensed band or unlicensed band). For example, it is agreed in advance that the value of the step size is bound to the SCS or the frequency band type.

For example: The UE performs blind detection on different SCSs. If an NCD-SSB is detected according to SCS=120 KHz, the step size at this time is considered to be 6. If an NCD-SSB is detected according to SCS=480 KHz, it is considered that the step size at this time is 24. Namely, when SCS=120 KHz is agreed in advance, the corresponding bound step size is 6. When SCS-480 KHz is agreed in advance, the corresponding bound step size is 24.

In some embodiments, the UE can determine the value of the step size according to whether the frequency band type is a licensed band or an unlicensed band (based on the fact that a sync raster at the licensed band and a sync raster at the unlicensed band do not overlap at all). For example, at the licensed band, the step size is 3; and at the unlicensed band, the step size is 6.

In this way, the terminal can determine the step size according to the SCS or the frequency band type, and then determine a position (i.e. frequency-domain position) of a CD-SSB synchronization raster.

Step 3: The UE finds out a position of a CD-SSB sync raster according to an indication and performs SSB detection.

### Embodiment IV

If a UE detects a first SSB and determines that a control resource set (CORESET) of a Type0-PDCCH common search space (CSS) does not exist, in a case of frequency band FR1 24≤k_{SSB}≤29 or FR2 12≤k_{SSB}≤13, the terminal can determine a GSCN of the nearest second SSB in a corresponding frequency band direction. The second SSB has a CORESET for being associated with the Type0-PDCCH CSS. The second SSB is set to N_{GSCN}^{Reference}+N_{GSCN}^{Size}·N_{GSCN}^{Offset}, where N_{GSCN}^{Reference} is a GSCN of the first SSB. For FR1 and FR2-1: N_{GSCN}^{Size}=1; for FR2-2: N_{GSCN}^{Size} is a step size defined in Table 4 below; for FR1: N_{GSCN}^{Offset} is a GSCN offset shown in FIG. 2a; and for FR2: N_{GSCN}^{Offset} is a GSCN offset shown in FIG. 2b. If the UE detects a second SSB and the second SSB does not provide a CORESET for the Type0-PDCCH CSS, the UE can ignore information that is used for performing cell searching and is related to a GSCN location of the SSB.

TABLE 4
Step sizes at different SCSs and different operating bands

| Subcarrier spacing common | | Step size |
|---|---|---|
| (subCarrierSpacingCommon) | NR operating band | N_{GSCN}^{Size} |
| scs120 | n264 (licensed band) | 3 |
| scs480 | n264 (licensed band) | 12 |
| scs120 | n263 (unlicensed band) | 6 |
| scs480 | n263 (unlicensed band) | 24 |

If the UE detects one SSB and determines that the CORESET of the Type0-PDCCH CSS does not exist, for frequency band FR1 k_{SSB}=31 or frequency band FR2 k_{SSB}=15, the terminal determines that there is no Type0-PDCCH CSS associated with the SSB within a GSCN range [N_{GSCN}^{Reference}−N_{GSCN}^{Size}·N_{GSCN}^{Start}, N_{GSCN}^{Reference}+N_{GSCN}^{Size}·N_{GSCN}^{End}], where N_{GSCN}^{Start} and N_{GSCN}^{End} are respectively determined by control resource set 0 (CORESET #0) and search space 0 (searchSpace #0) in pdcch-ConfigSIB1; and N_{GSCN}^{Size} is a step size defined in Table 4 above. If the GSCN range is [N_{GSCN}^{Reference}, N_{GSCN}^{Reference}], the UE determines that detected SSBs do not contain information about a second SSB information. The second SSB has a CORESET for being associated with the Type0-PDCCH CSS.

### Embodiment V

If a UE detects a first SSB and determines that a CORESET of a Type0-PDCCH CSS does not exist, in a case of frequency band FR1 24≤k_{SSB}≤29 or FR2 12≤k_{SSB}≤13, the terminal can determine a GSCN of the nearest second SSB in a corresponding frequency band direction. The second SSB has a CORESET for being associated with the Type0-PDCCH CSS. The second SSB is set to N_{GSCN}^{Reference}+N_{GSCN}^{Size}·N_{GSCN}^{Offset}, where N_{GSCN}^{Reference} is a GSCN of the first SSB. For FR1 and FR2-1: N_{GSCN}^{Size}=1; for FR2-2: N_{GSCN}^{Size} is a step size defined in Table 5 below; for FR1: N_{GSCN}^{Offset} is a GSCN offset shown in FIG. 2a; and for FR2: N_{GSCN}^{Offset} is a GSCN offset shown in FIG. 2b. If the UE detects a second SSB and the second SSB does not provide a CORESET for the Type0-PDCCH CSS, the UE can ignore information that is used for performing cell searching and is related to a GSCN location of the SSB.

TABLE 5
Step sizes at different operating bands

| NR operating band (operating band) | N_{GSCN}^{Size} |
|---|---|
| n263 (unlicensed band) | 3 or 6 |
| n264 (licensed band) | 12 or 24 |

If the UE detects one SSB and determines that the CORESET of the Type0-PDCCH CSS does not exist, for frequency band FR1 k_{SSB}=31 or frequency band FR2 k_{SSB}=15, the terminal determines that there is no Type0-PDCCH CSS associated with the SSB within a GSCN Start range [N_{GSCN}^{Reference}−N_{GSCN}^{Size}·N_{GSCN}^{Start}, N_{GSCN}^{Reference}+N_{GSCN}^{Size}·N_{GSCN}^{End}], where N_{GSCN}^{Start} and N_{GSCN}^{End} are respectively determined by control resource set 0 (CORESET #0) and search space 0 (searchSpace #0) in pdcch-ConfigSIB1; and N_{GSCN}^{Size} is a step size defined in Table 5 above. If the GSCN range is [N_{GSCN}^{Reference}, N_{GSCN}^{Reference}], the UE determines that detected SSBs do not contain information about a second SSB information. The second SSB has a CORESET for being associated with the Type0-PDCCH CSS.

### Embodiment VI

If a UE detects a first SSB and determines that a CORESET of a Type0-PDCCH CSS does not exist, in a case of frequency band FR1 24≤k_{SSB}≤29 or FR2 12≤k_{SSB}≤13, the terminal can determine a GSCN of the nearest second SSB in a corresponding frequency band direction. The second SSB has a CORESET for being associated with the Type0-PDCCH CSS. The second SSB is set to N_{GSCN}^{Reference}+N_{GSCN}^{Size}·N_{GSCN}^{Offset}, where N_{GSCN}^{Reference} is a GSCN of the first SSB. For FR1 and FR2-1: N_{GSCN}^{Size}=1; for FR2-2: N_{GSCN}^{Size} is a step size defined in Table 6 below; for FR1: N_{GSCN}^{Offset} is a GSCN offset shown in FIG. 2a; and for FR2; N_{GSCN}^{Offset} is a GSCN offset shown in FIG. 2b. If the UE detects a second SSB and the second SSB does not provide a CORESET for the Type0-PDCCH CSS, the UE can ignore information that is used for performing cell searching and is related to a GSCN location of the SSB.

TABLE 6
Step sizes corresponding to different subcarrier spacings

| Subcarrier spacing common | |
|---|---|
| (subCarrierSpacingCommon) | N_{GSCN}^{Size} |
| scs120 | 3 or 6 |
| scs480 | 12 or 24 |

If the UE detects one SSB and determines that the CORESET of the Type0-PDCCH CSS does not exist, for frequency band FR1 k_{SSB}=31 or frequency band FR2 k_{SSB}=15, the terminal determines that there is no Type0-PDCCH CSS associated with the SSB within a GSCN range [N_{GSCN}^{Reference}−N_{GSCN}^{Size}·N_{GSCN}^{Start}, N_{GSCN}^{Reference}+N_{GSCN}^{Size}·N_{GSCN}^{End}], where N_{GSCN}^{Start} and N_{GSCN}^{End} are respectively determined by control resource set 0 (CORESET #0) and search space 0 (searchSpace #0) in pdcch-ConfigSIB1; and N_{GSCN}^{Size} is a step size defined in Table 6 above. If the GSCN range is [N_{GSCN}^{Reference}, N_{GSCN}^{Reference}], the UE determines that detected SSBs do not contain information about a second SSB information. The second SSB has a CORESET for being associated with the Type0-PDCCH CSS.

An executive body of the information determination method provided by the embodiments of this application may be an information determination apparatus. In the embodiments of this application, using the information determination apparatus to perform the information determination method is taken as an example to explain the information determination apparatus provided by the embodiments of this application.

Referring to FIG. 4, FIG. 4 is a structural diagram of an information determination apparatus according to an embodiment of this application. As shown in FIG. 4, the information determination apparatus 400 includes:
a first determining module 401, configured to: determine first information based on a NCD-SSB detected on a first synchronization raster, wherein the first information includes at least one piece of information in a MIB in the NCD-SSB, first resource information of the first synchronization raster, or a SCS of the NCD-SSB; and
a second determining module 402, configured to determine target information based on the first information, wherein the target information includes at least one of the following:
second resource information of a first frequency-domain resource on which a second synchronization raster exists, wherein the second synchronization raster is a synchronization raster of a CD-SSB; and
third resource information of a second frequency-domain resource on which no CD-SSB exists.

In some embodiments, the first resource information of the first synchronization raster includes at least one of the following:
a frequency band type of a frequency band where the first synchronization raster is located;
a frequency band position of the frequency band where the first synchronization raster is located; and
a frequency band number of the frequency band where the first synchronization raster is located.

In some embodiments, the second determining module 402 includes:
a first determining unit, configured to determine a target step size based on the first information, wherein the target step size is used for indicating the second synchronization raster and/or used for indicating the second frequency-domain resource on which no CD-SSB exists; and
a second determining unit, configured to determine target information based on the target step size and second information,
wherein the second information includes at least one of the following:
a frequency-domain number or a frequency-domain position of the first synchronization raster; and
a frequency-domain number offset parameter or a frequency-domain position offset parameter of the second synchronization raster relative to the first synchronization raster.

In some embodiments, the first determining unit is further configured to execute at least one of the following:
determining the target step size based on an indication in an indication field of the MIB in the detected NCD-SSB;
determining the target step size based on the frequency band type of the frequency band where the first synchronization raster is located, wherein different frequency band types correspond to different step sizes;
determining the target step size based on the frequency band number of the frequency band where the first synchronization raster is located, wherein different frequency band numbers correspond to different step sizes; and
determining the target step size based on the SCS of the detected NCD-SSB, wherein the SCSs of different SSBs correspond to different step sizes.

In some embodiments, the second determining unit is further configured to:
determine a first product based on the target step size and the frequency-domain position offset parameter; and
determine a frequency-domain position of the second synchronization raster based on a sum of the first product and the frequency-domain position of the first synchronization raster.

In some embodiments, the frequency-domain number or the frequency-domain position of the first synchronization raster includes a GSCN of the first synchronization raster, and the second determining unit is further configured to:
determine a second product based on the target step size and the frequency-domain number offset parameter or the frequency-domain position offset parameter; and
determine a GSCN of the second synchronization raster based on a sum of the second product and the GSCN of the first synchronization raster.

In some embodiments, the first information is indicated through a bit in a first indication field in the MIB, and the first indication field is an indication field in a PBCH in the MIB.

In some embodiments, the first indication field includes at least one of the following:
a system frame number indication field;
a subcarrier spacing indication field;
a DMRS-type A-position indication field;
cell barred indication field;
an intra frequency reselection indication field; and
a spare indication field.

In some embodiments, the apparatus further includes a detection module; and the detection module is configured to execute at least one of the following:
in a case of determining, based on the first information, the first frequency-domain resource of the second synchronization raster on which a CD-SSB exists, performing SSB detection on the first frequency-domain resource; and
in a case of determining, based on the first information, the second frequency-domain resource on which no CD-SSB exists, not performing SSB detection on the second frequency-domain resource.

In this embodiment of this application, at initial access to a cell, after detecting the NCD-SSB on the first synchronization raster, the apparatus can determine, based on the first information, the frequency-domain resource of the second synchronization raster on which a CS-SSB exists, so that the apparatus can perform the SSB detection based on the frequency-domain resource of the second synchronization raster, to ensure that the apparatus can access to the cell quickly, and the efficiency of the apparatus accessing to the cell is improved. In addition, the apparatus can further determine, based on the first information, the frequency-domain resource on which no CD-SSB exists, to avoid the apparatus from performing the SSB detection on the frequency-domain resource on which no CD-SSB exists. This is more helpful for the apparatus to quickly locate an SSB to access to a cell.

The information determination apparatus 400 in this embodiment of this application may be an electronic device, for example, an electronic device having an operating system, or a component in an electronic device, such as an integrated circuit or a chip. The electronic device may be a terminal or another device except a terminal. Exemplarily, the terminal may include, but is not limited to, the types of the terminal 11 listed above, and the other device may be a server, a network attached storage (Network Attached Storage, NAS), or the like. The embodiments of this application do not impose a specific limitation on this.

The information determination apparatus 400 provided in this embodiment of this application can implement the various processes implemented by the terminal shown in the method embodiment of FIG. 3 and achieve the same technical effects, details of which are omitted here for brevity.

In some embodiments, as shown in FIG. 5, the embodiments of this application further provide a communication device 500, including a processor 501 and a memory 502. The memory 502 stores a program or an instruction runnable on the processor 501. For example, when the communication device 500 is a terminal, the program or instruction, when run by the processor 501, implements all the steps of the above method embodiment in FIG. 3 and can achieve the same technical effects, details of which are omitted here for brevity.

The embodiments of this application further provide a terminal, including a processor and a communication interface. The processor is configured to: determine first information based on a NCD-SSB detected on a first synchronization raster, wherein the first information includes at least one piece of information in a MIB in the NCD-SSB, first resource information of the first synchronization raster, or a SCS of the NCD-SSB; and configured to determine target information based on the first information, wherein the target information includes at least one of the following:
second resource information of a first frequency-domain resource on which a second synchronization raster exists, wherein the second synchronization raster is a synchronization raster of a CD-SSB; and
third resource information of a second frequency-domain resource on which no CD-SSB exists.

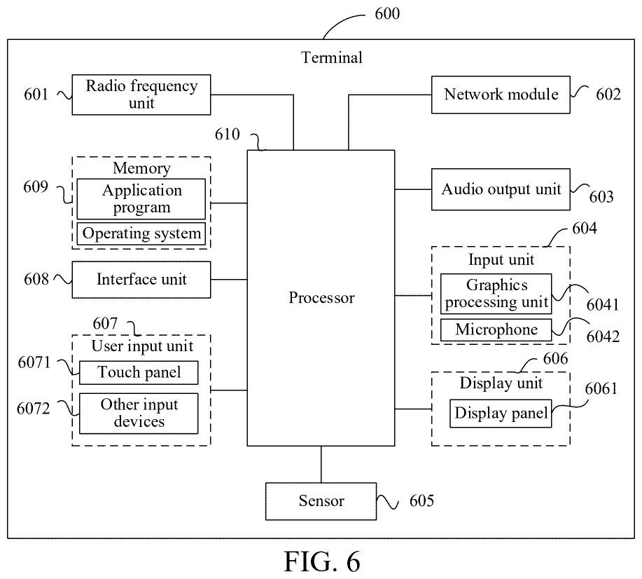

The terminal embodiment corresponds to the terminal side method embodiment described above. All the implementation processes and implementations of the above method embodiment can be applied to the terminal embodiment, and can achieve the same technical effect. For example, FIG. 6 is a schematic structural diagram of hardware of a terminal for implementing the embodiments of this application.

The terminal 600 includes, but is not limited to: at least some of a radio frequency unit 601, a network module 602, an audio output unit 603, an input unit 604, a sensor 605, a display unit 606, a user input unit 607, an interface unit 608, a memory 609, a processor 610, and the like.

Those skilled in the art can understand that the terminal 600 further includes a power supply (such as a battery) for supplying power to the various components. The power supply may be logically connected to the processor 610 by using a power management system, thereby implementing functions such as charging, discharging, and power consumption management by using the power management system. The structures of the terminal shown in FIG. 6 constitute no limitation on the terminal, and the terminal may include more or fewer components than those shown in the figure, or some components may be combined, or a different component deployment may be used, details of which are omitted here.

It should be understood that in the embodiments of this application, the input unit 604 may include a Graphics Processing Unit (GPU) 6041 and a microphone 6042, and the GPU 6041 processes image data of static pictures or videos obtained by an image capturing apparatus (such as a camera) in a video capturing mode or an image capturing mode. The display unit 606 may include a display panel 6061, and the display panel 6061 may be configured by using a liquid crystal display, an organic light-emitting diode, or the like. The user input unit 607 includes at least one of a touch panel 6071 and another input device 6072. The touch panel 6071 is also referred to as a touchscreen. The touch panel 6071 may include two parts: a touch detection apparatus and a touch controller. The another input device 6072 may include, but not limited to, a physical keyboard, a function key (such as a volume control key or a switch key), a track ball, a mouse, and a joystick, which is not described herein again.

In the embodiments of this application, the radio frequency unit 601 receives downlink data from a network side device and can transmit the data to the processor 610 for processing. In addition, the radio frequency unit 601 may transmit uplink data to the network side device. Generally, the radio frequency unit 601 includes, but is not limited to, an antenna, an amplifier, a transceiver, a coupler, a low noise amplifier, a duplexer, and the like.

The memory 609 may be configured to store a software program or an instruction and various data. The memory 609 may mainly include a first storage area for storing a program or instructions, and a second storage area for storing data. The first storage area may store an operating system, an application program or instructions required by at least one function (for example, a sound playing function and an image display function), and the like. The memory 609 may be a volatile memory or a non-volatile memory, or the memory 609 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), and a Direct Rambus RAM (DRRAM). The memory 609 in the embodiments of this application includes these and any other suitable types of memories.

The processor 610 may include one or more processing units. In some embodiments, the processor 610 may integrate an application processor and a modem processor, wherein the application processor mainly processes operations involving an operating system, a user interface, an application program, and the like, and the modem processor mainly processes a wireless communication signal, such as a baseband processor. It can be understood that, the modem processor may not be integrated into the processor 610.

The processor 610 is configured to: determine first information based on a NCD-SSB detected on a first synchronization raster, wherein the first information includes at least one piece of information in a MIB in the NCD-SSB, first resource information of the first synchronization raster, or a SCS of the NCD-SSB; and
configured to determine target information based on the first information, wherein the target information includes at least one of the following:
second resource information of a first frequency-domain resource on which a second synchronization raster exists, wherein the second synchronization raster is a synchronization raster of a CD-SSB; and
third resource information of a second frequency-domain resource on which no CD-SSB exists.

In some embodiments, the first resource information of the first synchronization raster includes at least one of the following:
a frequency band type of a frequency band where the first synchronization raster is located;
a frequency band position of the frequency band where the first synchronization raster is located; and
a frequency band number of the frequency band where the first synchronization raster is located.

In some embodiments, the processor 610 is further configured to:
determine a target step size based on the first information, wherein the target step size is used for indicating the second synchronization raster and/or used for indicating the second frequency-domain resource on which no CD-SSB exists; and
determine target information based on the target step size and second information,
wherein the second information includes at least one of the following:
a frequency-domain number or a frequency-domain position of the first synchronization raster; and
a frequency-domain number offset parameter or a frequency-domain position offset parameter of the second synchronization raster relative to the first synchronization raster.

In some embodiments, the processor 610 is further configured to perform at least one of the following:
determining the target step size based on an indication in an indication field of the MIB in the detected NCD-SSB;
determining the target step size based on the frequency band type of the frequency band where the first synchronization raster is located, wherein different frequency band types correspond to different step sizes;
determining the target step size based on the frequency band number of the frequency band where the first synchronization raster is located, wherein different frequency band numbers correspond to different step sizes; and
determining the target step size based on the SCS of the detected NCD-SSB, wherein the SCSs of different SSBs correspond to different step sizes. In some embodiments, the processor 610 is further configured to:
determine a first product based on the target step size and the frequency-domain position offset parameter; and
determine a frequency-domain position of the second synchronization raster based on a sum of the first product and the frequency-domain position of the first synchronization raster.

In some embodiments, the frequency-domain number or the frequency-domain position of the first synchronization raster includes a GSCN of the first synchronization raster, and the processor 610 is further configured to:
determine a second product based on the target step size and the frequency-domain number offset parameter or the frequency-domain position offset parameter; and
determine a GSCN of the second synchronization raster based on a sum of the second product and the GSCN of the first synchronization raster.

In some embodiments, the first information is indicated through a bit in a first indication field in the MIB, and the first indication field is an indication field in a PBCH in the MIB.

In some embodiments, the first indication field includes at least one of the following:
a system frame number indication field;
a subcarrier spacing indication field;
a DMRS-type A-position indication field;
cell barred indication field;
an intra frequency reselection indication field; and
a spare indication field.

In some embodiments, the processor 610 is further configured to perform at least one of the following:
in a case that the terminal determines, based on the first information, the first frequency-domain resource of the second synchronization raster on which a CD-SSB exists, performing SSB detection on the first frequency-domain resource; and
in a case that the terminal determines, based on the first information, the second frequency-domain resource on which no CD-SSB exists, not performing SSB detection on the second frequency-domain resource.

In this embodiment of this application, at initial access to a cell, after detecting the NCD-SSB on the first synchronization raster, the terminal can determine, based on the first information, the frequency-domain resource of the second synchronization raster on which a CS-SSB exists, so that the terminal can perform the SSB detection based on the frequency-domain resource of the second synchronization raster, to ensure that the terminal can access to the cell quickly, and the efficiency of the terminal accessing to the cell is improved. In addition, the terminal can further determine, based on the first information, the frequency-domain resource on which no CD-SSB exists, to avoid the terminal from performing the SSB detection on the frequency-domain resource on which no CD-SSB exists. This can effectively improve the efficiency of blind detection of the terminal and is more helpful for the terminal to quickly locate an SSB to access to a cell.

The embodiments of this application further provide a readable storage medium. The readable storage medium stores a program or an instruction. The program or instruction, when run or executed by a processor, implements the various processes of the foregoing information determination method embodiment and can achieve the same technical effects, details of which are omitted here for brevity.

The processor is the processor in the terminal in the embodiments described above. The readable storage medium includes a computer-readable storage medium, for example, a computer ROM, a RAM, a magnetic disc, a compact disc, or the like.

The embodiments of this application further provide a chip. The chip includes a processor and a communication interface. The communication interface is coupled to the processor. The processor is configured to run or execute a program or an instruction to implement the various processes of the information determination method embodiment, and can achieve the same technical effects, details of which are omitted here for brevity.

In some embodiments, it should be understood that the chip mentioned in the embodiments of this application can be referred to as a system chip, a chip system, or a system-on-chip.

The embodiments of this application further provide a computer program/program product. The computer program/program product is stored in a storage medium. The computer program/program product, when run by at least one processor, implements the various processes of the foregoing information determination method embodiment and can achieve the same technical effects, details of which are omitted here for brevity.

The embodiments of this application further provide a communication system, including: a terminal and a network side device. The terminal can be configured to execute the steps of the above information determination method.

It should be noted that, the terms “include”, “comprise”, or any other variations thereof herein are intended to cover a non-exclusive inclusion, so that a processor, method, object, or apparatus including a series of elements not only includes those elements, but also includes other elements not specifically listed, or includes inherent elements of this process, method, object, or apparatus. Without more limitations, elements defined by the sentence “including one” does not exclude that there are still other same elements in the process, method, object, or apparatus including these elements. In addition, it should be noted that the scope of the methods and devices in the embodiments of this application is not limited to executing functions in the order shown or discussed, but may alternatively include executing functions in a substantially simultaneous manner or in an opposite order according to the functions involved. For example, the methods described may be executed in a different order than that described, and various steps may alternatively be added, omitted, or combined. In addition, features described with reference to some examples may alternatively be combined in other examples.

According to the descriptions in the foregoing implementations, a person skilled in the art may clearly learn that the method according to the foregoing embodiment may be implemented by relying on software and an essential commodity hardware platform or by using hardware, but the former is a better implementation in most cases. Based on such an understanding, the technical solutions of this application essentially, or the part contributing to the prior art, may be presented in the form of a computer software product. The computer software product is stored in a storage medium (for example, a ROM/RAM, a magnetic disc, or a compact disc) including several instructions to enable a terminal (which may be a mobile phone, a computer, a server, an air conditioner, a network device, or the like) to perform the methods described in all the embodiments of this application.

The embodiments of this application have been described above with reference to the accompanying drawings. This application is not limited to the specific implementations described above, and the specific implementations described above are merely examples and not limitative. Those of ordinary skill in the art may make various forms under the teaching of this application without departing from the spirit of this application and the protection scope of the claims, and these forms shall all fall within the protection of this application.

What is claimed is:

1. An information determination method, comprising:
determining, by a terminal, first information based on a non cell defining synchronization signal and PBCH block (NCD-SSB) detected on a first synchronization raster, wherein the first information comprises at least one piece of information in a master information block (MIB) in the NCD-SSB, first resource information of the first synchronization raster, or a subcarrier spacing (SCS) of the NCD-SSB; and
determining, by the terminal, target information based on the first information, wherein the target information comprises at least one of the following:
second resource information of a first frequency-domain resource on which a second synchronization raster exists, wherein the second synchronization raster is a synchronization raster of a cell defining synchronization signal and PBCH block (CD-SSB); or
third resource information of a second frequency-domain resource on which no CD-SSB exists.

2. The method according to claim 1, wherein the first resource information of the first synchronization raster comprises at least one of the following:
a frequency band type of a frequency band where the first synchronization raster is located;
a frequency band position of the frequency band where the first synchronization raster is located; or
a frequency band number of the frequency band where the first synchronization raster is located.

3. The method according to claim 1, wherein the determining, by the terminal, the target information based on the first information comprises:
determining, by the terminal, a target step size based on the first information, wherein the target step size is used for indicating the second synchronization raster or used for indicating the second frequency-domain resource on which no CD-SSB exists; and
determining, by the terminal, target information based on the target step size and second information,
wherein the second information comprises at least one of the following:
a frequency-domain number or a frequency-domain position of the first synchronization raster; or
a frequency-domain number offset parameter or a frequency-domain position offset parameter of the second synchronization raster relative to the first synchronization raster.

4. The method according to claim 3, wherein the determining, by the terminal, the target step size based on the first information comprises at least one of the following:
determining, by the terminal, the target step size based on an indication in an indication field of the MIB in the detected NCD-SSB;
determining, by the terminal, the target step size based on a frequency band type of the frequency band where the first synchronization raster is located, wherein different frequency band types correspond to different step sizes;
determining, by the terminal, the target step size based on the frequency band number of the frequency band where the first synchronization raster is located, wherein different frequency band numbers correspond to different step sizes; or
determining, by the terminal, the target step size based on the SCS of the detected NCD-SSB, wherein SCSs of different SSBs correspond to different step sizes.

5. The method according to claim 3, wherein the determining, by the terminal, the target information based on the target step size and second information comprises:
determining, by the terminal, a first product based on the target step size and the frequency-domain position offset parameter; and
determining, by the terminal, a frequency-domain position of the second synchronization raster based on a sum of the first product and the frequency-domain position of the first synchronization raster.

6. The method according to claim 3, wherein the frequency-domain number or the frequency-domain position of the first synchronization raster comprises a global synchronization channel number (GSCN) of the first synchronization raster, and the determining, by the terminal, the target information based on the target step size and second information comprises:
determining, by the terminal, a second product based on the target step size and the frequency-domain number offset parameter or the frequency-domain position offset parameter; and
determining, by the terminal, a GSCN of the second synchronization raster based on a sum of the second product and the GSCN of the first synchronization raster.

7. The method according to claim 1, wherein the first information is indicated through a bit in a first indication field in the MIB, and the first indication field is an indication field in a physical broadcast channel (PBCH) in the MIB.

8. The method according to claim 7, wherein the first indication field comprises at least one of the following:
a system frame number indication field;
a subcarrier spacing indication field;
a demodulation reference signal (DMRS)-type A-position indication field;
cell barred indication field;
an intra frequency reselection indication field; or
a spare indication field.

9. The method according to claim 1, further comprising at least one of the following:
when the terminal determines, based on the first information, the first frequency-domain resource of the second synchronization raster on which a CD-SSB exists, performing, by the terminal, SSB detection on the first frequency-domain resource; or
when the terminal determines, based on the first information, the second frequency-domain resource on which no CD-SSB exists, not performing, by the terminal, SSB detection on the second frequency-domain resource.

10. A terminal, comprising a processor and a memory storing instructions, wherein the instructions, when executed by the processor, cause the processor to perform operations comprising:
determining first information based on a non cell defining synchronization signal and PBCH block (NCD-SSB) detected on a first synchronization raster, wherein the first information comprises at least one piece of information in a master information block (MIB) in the NCD-SSB, first resource information of the first synchronization raster, or a subcarrier spacing (SCS) of the NCD-SSB; and
determining target information based on the first information, wherein the target information comprises at least one of the following:
second resource information of a first frequency-domain resource on which a second synchronization raster exists, wherein the second synchronization raster is a synchronization raster of a cell defining synchronization signal and PBCH block (CD-SSB); or
third resource information of a second frequency-domain resource on which no CD-SSB exists.

11. The terminal according to claim 10, wherein the first resource information of the first synchronization raster comprises at least one of the following:
a frequency band type of a frequency band where the first synchronization raster is located;
a frequency band position of the frequency band where the first synchronization raster is located; or
a frequency band number of the frequency band where the first synchronization raster is located.

12. The terminal according to claim 10, wherein the determining the target information based on the first information comprises:
determining a target step size based on the first information, wherein the target step size is used for indicating the second synchronization raster or used for indicating the second frequency-domain resource on which no CD-SSB exists; and
determining target information based on the target step size and second information,
wherein the second information comprises at least one of the following:
a frequency-domain number or a frequency-domain position of the first synchronization raster; or
a frequency-domain number offset parameter or a frequency-domain position offset parameter of the second synchronization raster relative to the first synchronization raster.

13. The terminal according to claim 12, wherein the determining the target step size based on the first information comprises at least one of the following:
determining the target step size based on an indication in an indication field of the MIB in the detected NCD-SSB;
determining the target step size based on a frequency band type of the frequency band where the first synchronization raster is located, wherein different frequency band types correspond to different step sizes;
determining the target step size based on the frequency band number of the frequency band where the first synchronization raster is located, wherein different frequency band numbers correspond to different step sizes; or
determining the target step size based on the SCS of the detected NCD-SSB, wherein SCSs of different SSBs correspond to different step sizes.

14. The terminal according to claim 12, wherein the determining the target information based on the target step size and second information comprises:
determining a first product based on the target step size and the frequency-domain position offset parameter; and
determining a frequency-domain position of the second synchronization raster based on a sum of the first product and the frequency-domain position of the first synchronization raster.

15. The terminal according to claim 12, wherein the frequency-domain number or the frequency-domain position of the first synchronization raster comprises a global synchronization channel number (GSCN) of the first synchronization raster, and the determining the target information based on the target step size and second information comprises:
determining a second product based on the target step size and the frequency-domain number offset parameter or the frequency-domain position offset parameter; and
determining a GSCN of the second synchronization raster based on a sum of the second product and the GSCN of the first synchronization raster.

16. The terminal according to claim 10, wherein the first information is indicated through a bit in a first indication field in the MIB, and the first indication field is an indication field in a physical broadcast channel (PBCH) in the MIB.

17. The terminal according to claim 16, wherein the first indication field comprises at least one of the following:
a system frame number indication field;
a subcarrier spacing indication field;
a demodulation reference signal (DMRS)-type A-position indication field;
cell barred indication field;
an intra frequency reselection indication field; or
a spare indication field.

18. The terminal according to claim 10, wherein the instructions, when executed by the processor, cause the processor to further perform at least one of the following operations:
when the terminal determines, based on the first information, the first frequency-domain resource of the second synchronization raster on which a CD-SSB exists, performing, by the terminal, SSB detection on the first frequency-domain resource; or
when the terminal determines, based on the first information, the second frequency-domain resource on which no CD-SSB exists, not performing, by the terminal, SSB detection on the second frequency-domain resource.

19. A non-transitory computer-readable storage medium storing instructions that, when executed by a processor, cause the processor to perform operations comprising:
determining first information based on a non cell defining synchronization signal and PBCH block (NCD-SSB) detected on a first synchronization raster, wherein the first information comprises at least one piece of information in a master information block (MIB) in the NCD-SSB, first resource information of the first synchronization raster, or a subcarrier spacing (SCS) of the NCD-SSB; and
determining target information based on the first information, wherein the target information comprises at least one of the following:
second resource information of a first frequency-domain resource on which a second synchronization raster exists, wherein the second synchronization raster is a synchronization raster of a cell defining synchronization signal and PBCH block (CD-SSB); or
third resource information of a second frequency-domain resource on which no CD-SSB exists.

20. The non-transitory computer-readable storage medium according to claim 19, wherein the first resource information of the first synchronization raster comprises at least one of the following:
a frequency band type of a frequency band where the first synchronization raster is located;
a frequency band position of the frequency band where the first synchronization raster is located; or
a frequency band number of the frequency band where the first synchronization raster is located.
